(19) United States
(12) Patent Application Publication
(10) Pub. No.: US 2007/0241046 A1
(43) Pub. Date: Oct. 18, 2007

(54) Food processing water recirculation system for cleaning screens

(75) Inventors: Daniel D. Maupin, Corvallis, OR (US); Vadim L. Tumarkin, Madison, WI (US)

Correspondence Address: MICHAEL BEST & FRIEDRICH LLP, 100 E WISCONSIN AVENUE, Suite 3300, MILWAUKEE, WI, 53202, US

(73) Assignee: Lyco Manufacturing, Inc., Columbus, WI (US)

(21) Appl. No.: 11/405,909

(22) Filed: Apr. 18, 2006

(51) Int. Cl. B01D 33/06

(52) U.S. Cl. 210/402

(57) ABSTRACT

A food processing system having a wastewater screen apparatus includes a recirculation system having a self-cleaning filter for receiving fluid from the wastewater screen apparatus. The filter is operable in a first mode wherein the filter screens particulate matter from the fluid and the filter is operable in a second mode wherein the filter is purged of the screened matter. A pump pumps cleaned fluid from the filter to the wastewater screen apparatus, wherein a substantially continuous supply of cleaned fluid is delivered to the pump. A first fluid flow path fluidly connects the wastewater screen apparatus, the filter, and the pump. A control valve is operable to direct fluid along the first fluid flow path when the filter is in the first mode and the control valve is operable to direct fluid and screened matter along a second fluid flow path when the filter is in the second mode.

### BACKGROUND

The present invention relates to food processing systems having a wastewater screen, and in particular, to a water recirculation system for using reclaimed and filtered water for cleaning the screen.

Wastewater is a byproduct of many industrial processes that use water, such as the food industry that relies on water for processing food. Water is used to clean vegetables, beef, fish, poultry, and other types of food often before the food is cooked, blanched or sterilized using other water. All the water used to clean the food product must also be processed to clean it for reuse or inexpensive disposal. Restrictive environmental laws and regulations have made disposal of unprocessed wastewater expensive, and wastewater processing or pre-processing at the site of the food processing facility is desirable.

One device effective at treating wastewater is a cylindrical-type wastewater screen, such as the one shown and described in U.S. Pat. No. 5,433,849. The cylindrical-type wastewater screen includes a cylindrical screen, typically comprised of perforate wedgewire, into which the wastewater is introduced while the screen is rotated. As shown, two cylindrical-type screens having successively finer screen media can be concentrically arranged to provide staged treatment of wastewater. The wastewater passes radially outwardly through the screen after which it can be reused, further filtered, or disposed. Solids entrained in the wastewater that were filtered out of the wastewater may be cheaply disposed of as landfill or fertilizer.

During operation, wastewater introduced within the cylindrical screen passes radially outwardly through perforations in the screen while most of the solids entrained in the wastewater are filtered by and retained in the screen. The filtered solids often cling to the screen and the screen is rotated to cause gravity to encourage the solids to separate from the screen and fall to the bottom of the screen. A small flow of wastewater at the bottom of the screen carries the solids from the screen helping to keep the screen clean.

Many times, sticky solids, such as fat, connective tissue, coatings, starch, and other sticky residue will continue to cling to the screen despite rotation of the screen. The sticky solids may also cause other solids in the wastewater to stick to it and can significantly reduce the efficiency of the screen by partially or completely plugging perforations. When too many perforations become plugged, the screen is taken off-line and cleaned.

To help keep the screen clean and prevent too many perforations from becoming plugged, nozzles carried by a manifold are disposed adjacent the screen and discharge cold water, hot water, steam or even air forcefully against the screen. On larger screens, such a spray cleaning system consumes vast amounts of fresh water, for example, 30 to 90 gallons of water per minute. In addition, stubborn materials often require higher than normal pressure to dislodge clogged materials, or to pass through multiple screens.

Spray cleaning systems have been developed that reduce the amount of fresh water used to clean the wastewater screens to 10 gallons per minute; however, even these low flows require 14,400 gallons per day, and if used year round would utilize over 5 million gallons of water. As water resources are becoming closely monitored and regulated, it is important to further reduce the amount of fresh water needed in the screen cleaning process in a reasonably economical way.

Some water recirculation systems incorporate a strainer or filter to filter wastewater and then reuse the water in the cleaning system. However, the strainer or filter can become plugged by solids in the wastewater. To clean the filters, the system must be shut down and manually cleaned, which increases inefficiency and cost of the system. Further, the reused wastewater includes particles that will plug the spray cleaning system.

### SUMMARY

In one embodiment, the invention provides a recirculation system for a food processing system having a wastewater screen apparatus. The recirculation system includes a self-cleaning filter for receiving fluid from the wastewater screen apparatus. The filter is operable in a first mode wherein the filter screens particulate matter from the fluid and the filter is operable in a second mode wherein the filter is purged of the screened matter. A pump pumps cleaned fluid from the filter to the wastewater screen apparatus, wherein a substantially continuous supply of cleaned fluid is delivered to the pump. A first fluid flow path fluidly connects the wastewater screen apparatus, the filter, and the pump. A control valve is operable to direct fluid along the first fluid flow path when the filter is in the first mode and the control valve is operable to direct fluid and screened matter along a second fluid flow path when the filter is in the second mode.

In another embodiment, the invention provides a recirculation system for use with a wastewater screen apparatus. The recirculation system includes a self-cleaning filter for receiving fluid from the wastewater screen apparatus. The filter is operable in a first mode wherein the filter screens particulate matter from the fluid and is operable in a second mode wherein the filter is purged of the screened matter. The recirculation system also includes a first pump for pumping water from the wastewater screen apparatus to the filter and a second pump for pumping cleaned fluid from the filter to the wastewater screen apparatus, wherein a substantially continuous supply of cleaned fluid is delivered to the second pump. A first fluid flow path fluidly connects the wastewater screen apparatus, the first pump. A fluid supply line is fluidly connected to the first fluid flow path downstream of the filter and upstream of the pump. A first control valve is operable to direct fluid from the wastewater screen apparatus to the filter through the first fluid flow path when the filter is in the first mode. The filter is also operable to direct fluid and screened matter from the filter and through a second fluid flow path when the filter is in the second mode. A second control valve is positioned downstream of the filter, wherein when the filter is in the first mode the second control valve is actuated to a first position to prevent fluid from the fluid supply line from entering the first fluid flow path. When the filter is in the second mode, the second control valve is actuated to a second position to allow a portion of fluid from the fluid supply line to flow to the pump and a remainder of the fluid from the fluid supply line to flow to the filter through the second fluid flow path.

In another embodiment, the invention provides a recirculation system for use with a wastewater screen apparatus. The recirculation system includes a self-cleaning filter for receiving fluid from the wastewater screen apparatus, the filter being operable in a first mode wherein the filter screens particulate matter from the fluid and the filter being operable in a second mode wherein the filter is purged of the screened matter. The recirculation system also includes a first pump for pumping water from the wastewater screen apparatus to the filter, an accumulation tank positioned downstream of the filter, wherein the accumulation tank stores cleaned fluid from the filter, and a second pump for pumping cleaned fluid from the accumulation tank to the wastewater screen apparatus, wherein a substantially continuous supply of cleaned fluid is delivered to the pump from the accumulation tank. A first fluid flow path fluidly connects the wastewater screen apparatus, the first pump, the filter, the accumulation tank, and the second pump. A control valve is operable to direct fluid along the first fluid flow path when the filter is in the first mode and is operable to divert fluid and screened matter from the first fluid flow path when the filter is in the second mode.

In yet another embodiment, the invention provides a high pressure water system for use with a wastewater screen apparatus. The high pressure water system includes a first fluid supply conduit for receiving fluid from the wastewater screen apparatus, a fluid delivery conduit for delivering fluid to the wastewater screen apparatus, and a self-cleaning filter for receiving fluid from the first fluid supply conduit. The filter is operable in a first mode wherein the filter screens particulate matter from the fluid and the filter is operable in a second mode wherein the filter is purged of the screened matter. The system includes a purge conduit fluidly connected to the first fluid supply conduit. A first control valve operable to direct fluid from the first fluid supply conduit to the filter when the filter is in the first mode, and the first control valve is operable to direct fluid and screened particles from the filter to the purge conduit when the filter is in the second mode. A pump pumps fluid from the filter to the fluid delivery conduit, wherein a substantially continuous supply of fluid is delivered to the pump. A fluid flow path extends between the filter and the pump. The system also includes a second water supply for delivering a second fluid to the fluid flow path when the filter is in the second mode, and a second control valve disposed in the fluid flow path. The second control valve is operable to prevent second fluid from the second water supply from entering the fluid flow path when the filter is in the first mode, and the second control valve is operable to allow a portion of second fluid to flow to the filter and a remainder of second fluid to flow to the pump when the filter is in second mode.

Yet another embodiment of the invention provides a wastewater screening system including a wastewater screen apparatus of a double screen type for cleaning particulate matter from wastewater, wherein screened wastewater is collected in a trough, and a recirculation system for further cleaning particulate matter from the screened wastewater and delivering the cleaned water to the wastewater screen apparatus. The recirculation system includes a self-cleaning filter for receiving screened wastewater from the trough, the filter being operable in a first mode wherein the filter screens matter from the screened wastewater and being operable in a second mode wherein the filter is purged of the screened matter. A pump pumps cleaned water from the filter to the wastewater screen apparatus, wherein a substantially continuous supply of cleaned water is delivered to the pump. A first fluid flow path fluidly connects the trough, the filter, the pump, and the wastewater screen apparatus. A control valve is operable to direct screened wastewater and cleaned water along the first fluid flow path when the filter is in the first mode, and the control valve is operable to direct purged water and screened matter through a second fluid flow path when the filter is in the second mode.

In still another embodiment, the invention provides a recirculation system for use with a wastewater screen apparatus. The recirculation system includes a self-cleaning filter for receiving fluid from the wastewater screen apparatus. The filter is operable in a first mode wherein the filter screens particulate matter from the fluid and the filter is operable in a second mode wherein the filter is purged of the screened matter. A pump pumps cleaned fluid from the filter to the wastewater screen apparatus, wherein a substantially continuous supply of cleaned fluid is delivered to the pump. A first fluid flow path fluidly connects the wastewater screen apparatus, the filter, and the pump. A control valve is operable to direct fluid along the first fluid flow path when the filter is in the first mode and the control valve is operable to direct fluid and screened matter along a second fluid flow path when the filter is in the second mode.

Other aspects of the invention will become apparent by consideration of the detailed description and accompanying drawings.

### BRIEF DESCRIPTION OF THE DRAWINGS

FIG. 1 is a perspective view of a dual cylindrical-type wastewater screen with certain parts being shown as broken away or removed for the sake of clarity.

FIG. 2 is a schematic diagram of a water recirculation system according to one embodiment of the invention, the system in a water cleaning mode.

FIG. 3 is a schematic diagram of the water recirculation system of FIG. 2 in a self-cleaning mode.

FIG. 4 is a perspective view of a high pressure water system for use in the water recirculation system.

FIG. 5 is a schematic diagram of a water recirculation system according to another embodiment of the invention, the system in a water cleaning mode.

FIG. 6 is a schematic diagram of the water recirculation system of FIG. 5 in a self-cleaning mode.

FIG. 7 is a schematic diagram of a water recirculation system according to another embodiment of the invention.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting.

### DETAILED DESCRIPTION

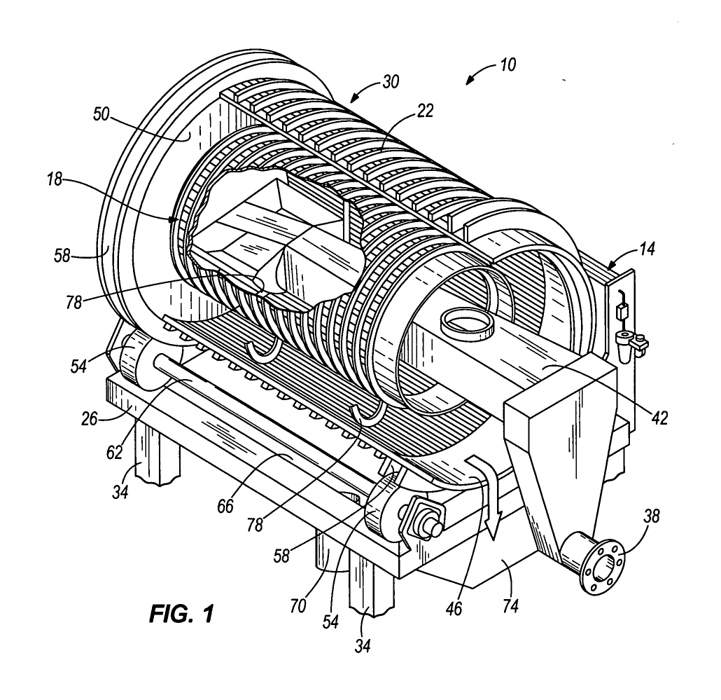

The present invention relates to a water recirculation system for use with a wastewater screen apparatus 10, and FIG. 1 illustrates one example of a double cylindrical wastewater screen apparatus 10. The wastewater screen apparatus 10 is used in a food processing facility to filter solids and particulate matter entrained in wastewater. The wastewater screen apparatus 10 includes a sprayer system, 14 which is shown as a reciprocating sprayer in FIG. 1, for cleaning cylindrical perforate screens 18, 22 of the wastewater screen apparatus 10 and remove suspended material from wastewater. The general arrangement and operation of a wastewater screen is described in U.S. Pat. No. 5,433,849, issued Jul. 18, 1995, which is incorporated by reference herein. The following detailed description of the wastewater screen apparatus 10 is provided for purposes of describing the present invention.

The wastewater screen apparatus 10 is mounted on a frame 26 that carries a double screen assembly 30 having concentrically arranged an inner drum screen 18 and an outer drum screen 22. Legs 34 space the apparatus 10 above the ground. Although not shown in FIG. 1, the apparatus 10 includes a housing that encompasses the screens 18, 22 and the sprayer system 14. Wastewater is introduced to one end of the wastewater screen apparatus 10 via an inlet 38 and conducted into the center of the inner cylindrical screen 18 via a conduit 42. In the illustrated embodiment, a discharge end 46 of the cylindrical screen 18 is adjacent the inlet 38.

In the illustrated embodiment, the screen assembly 30 is closed at an end opposite the discharge end 46 by a disc-shaped drum head 50, to which one or both cylindrical screens 18, 22 are fixed. Both screens 18, 22 are fixed to the head 50 for rotation in unison therewith about a common, longitudinal axis of rotation. The outer screen 22 of the screen assembly 30 is rotationally supported by rollers 54, or trunnions, that are received in spaced apart channels 58, or the like, carried by the outer screen 22. The wastewater screen apparatus 10 includes two pairs of spaced apart rollers 54 with each pair of rollers 54 carried by an axle 62 journaled for rotation to the frame 26. The rollers 54 are driven by a motor and conventional belt and pulleys (not shown).

Disposed below the screen assembly 30 is a trough 66 that serves as a collection pan for collecting the wastewater, as well as the cleaning fluid from the sprayer system 14, after it has passed through the screens 18, 22. The trough 66 has a drain 70 through which the screened wastewater is discharged. Collectively, the housing (not shown) and the trough 66 ensure the wastewater and the cleaning fluid are retained within the wastewater screen apparatus 10.

The discharge end 46 of the wastewater screen apparatus 10 is at least partially open so that solids screened from the wastewater are discharged from the apparatus 10. A second trough 74 is disposed below the screen assembly 30 adjacent the discharge end 46 for catching solids filtered from the wastewater. Each screen 18, 22 has a generally spiral-shaped or helical auger 78 positioned inside the screen to help urge solids toward the discharge end 46.

During operation, wastewater to be cleaned is delivered to the wastewater screen apparatus 10 through the inlet 38 is conducted through the conduit 42. The conduit 42 includes an outlet 82 disposed within the inner screen 18 for discharging the wastewater into the inner screen 18. In the illustrated embodiment, the outlet is 82 positioned adjacent the closed end of the screen assembly 30. Each screen 18, 22 may be inclined such that the closed end is disposed above the discharge end to spread the flow of wastewater more evenly over the entire axial length of each screen and to encourage the flow of solids out of the discharge end 46.

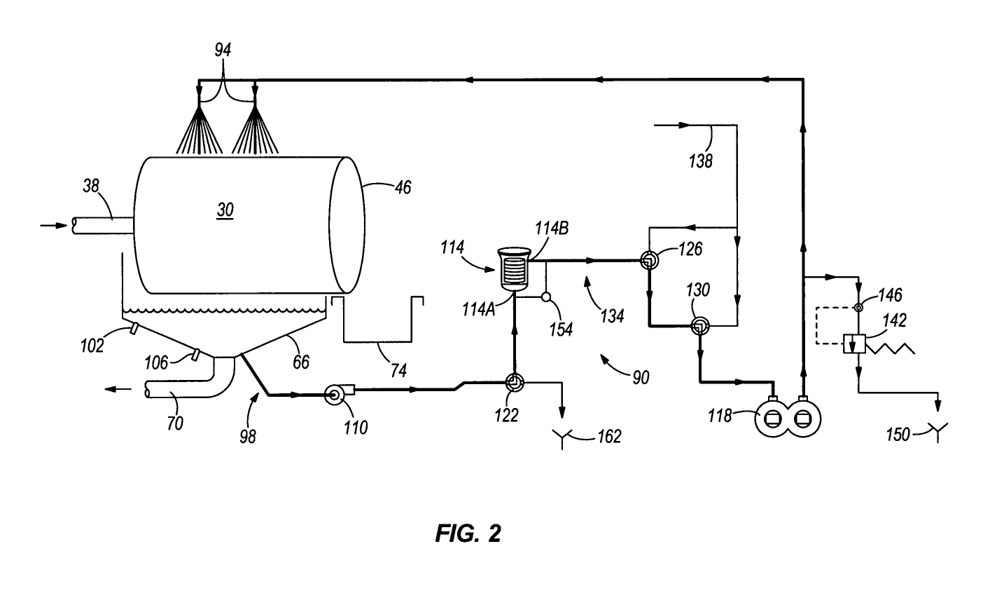

The wastewater passes radially outwardly through the inner and outer screens 18, 22 while a large portion of solids entrained in the wastewater are filtered by and retained in the screens 18, 22. The filtered solids often cling to the screens 18, 22, thereby the screens 18, 22 are rotated to cause the solids to separate from the screens 18, 22 and fall to the bottom of the outer screen 22. Further, the sprayer system 14 discharges a cleaning fluid forcefully against the outer screen 22 to separate the solids from the screens 18, 22. In the illustrated embodiment, the sprayer system 14 discharges water (hot or cold), although in further embodiments steam or air may be used to clean the screens 18, 22. Rotation of the screens 18, 22 causes the solids to travel to the discharge end 46 of the screen apparatus 10 for collection by the trough 74 (FIG. 2). The screened wastewater and cleaning fluid are collected by the first trough 66 and diverted to the water recirculation system, as described below.

In the illustrated embodiment, the inner and outer screens 18, 22 are formed of wedgewire. The inner screen 18 includes wedgewire sized to allow particulate matter with a size greater than 0.060 inches to pass through. The outer screen 22 includes wedgewire sized to allow particulate matter with a size greater than 0.010 inches to pass through. It should be readily apparent to those of skill in the art that other types of perforate screens may be used for the screen assembly 30 or that the screen openings may be smaller or larger than described.

It should be readily apparent to those of skill in the art that a single screen embodiment of the screen assembly 30 may be used. Further, besides a traveling sprayer system 14, other sprayer systems may be used, such as a fixed sprayer system or a sequential sprayer system. An example of a traveling sprayer system is shown and described in some detail in U.S. Pat. No. 6,182,833, issued Feb. 6, 2001, which has a common assignee with the present invention and is incorporated by reference herein. An example of a sequential sprayer system is shown and described in some detail in U.S. Pat. No. 6,419,094, which has a common assignee with the present invention and is incorporated by reference herein.

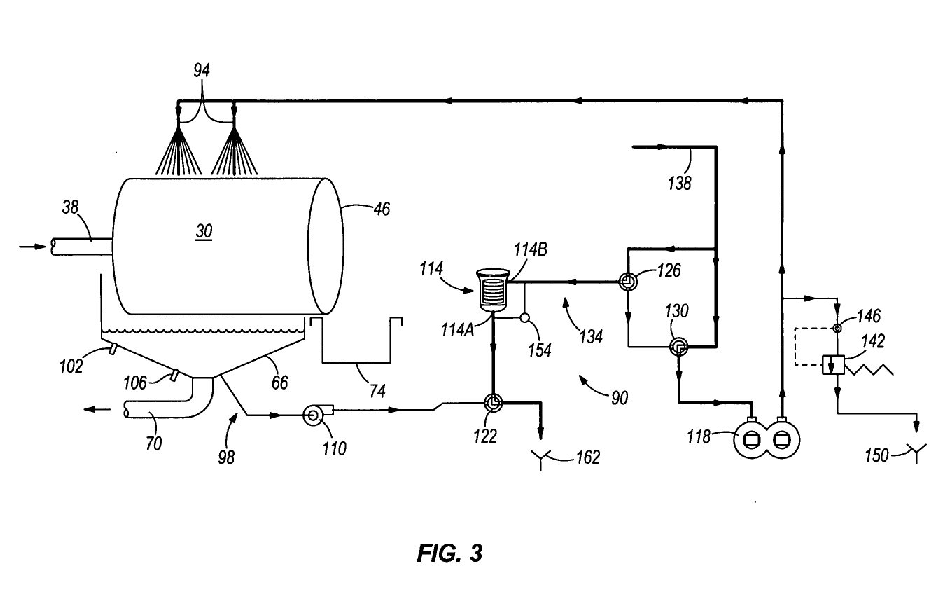

FIGS. 2 and 3 schematically illustrate a water recirculation system 90 according to one embodiment of the invention for use with the wastewater screen apparatus 10. Wastewater to be cleaned is delivered to the inlet 38 of the screen assembly 30 and the wastewater passes through the screen assembly 30 while a large portion of the solids entrained in the wastewater are filtered by and retained in the screen assembly 30.

Spray nozzles 94 carried by a manifold of the sprayer system (FIG. 1) are positioned about an outer surface of the screen assembly 30 for cleaning the solids from the screen assembly 30 and preventing perforations in the screens from becoming plugged. In the illustrated embodiment, each spray nozzle 94 discharges water at about 10 gallons per minute (gpm) against the screen assembly 30 and have a diameter of about 0.09 inches, although nozzles 94 having greater or less capacity may be used depending upon the solid and particulate matters entrained in the wastewater and the number or size of the screens.

The screen assembly 30, and thereby the screens, is rotated to cause the solids that often cling to the screens to separate from the screens and fall to the bottom of the screen assembly 30. The spray nozzles 94 also cause separation of the solids from the screens. Rotation of the screens causes the solids to travel to the discharge end 46 of the screen apparatus 10 where the solids are collected in the trough 74 positioned below the screen assembly 30 proximate the discharge end 46. The collected solids may be disposed of or used as fertilizer.

The screened wastewater and cleaning fluid are collected in the trough 66 positioned below the screen assembly 30. The trough 66 includes the drain 70 through which the screened wastewater and cleaning fluid are discharged for reuse, further filtering or disposal. A portion of the screened wastewater and cleaning fluid are diverted to the water recirculation system 90 along a recirculation path 98 for further processing and use as cleaning fluid for the spray nozzles 94. The trough 66 includes a high level sensor 102 and a low level sensor 106 for maintaining a desired amount of water in the trough 66 to feed the water recirculation system 90.

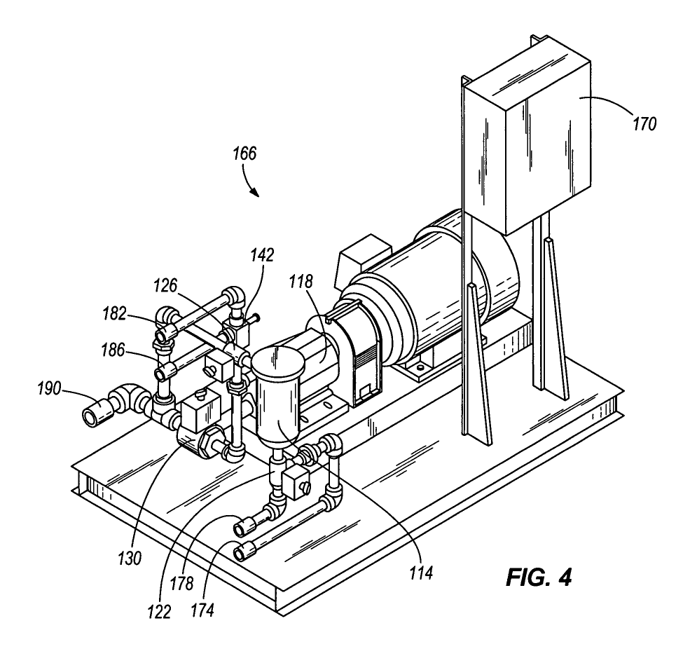

The water recirculation system 90 uses water already screened by the wastewater screen apparatus 10 to supply the sprayer system (FIG. 1) and nozzles 94 for cleaning the apparatus 10. The water recirculation system 90 includes a supply pump 110 and a high pressure water system (FIG. 4) having a self-cleaning filter 114, a high pressure pump 118, control valves 122, 126, 130 for regulating flow of the screened wastewater, and sensors for controlling flow through the water recirculation system 90. FIG. 2 shows the water circulation system 90 in a water cleaning mode, in which screened wastewater from the wastewater screen apparatus 10 is further cleaned by the filter 114 and returned to the spray nozzles 94 by the high pressure pump 118. A fluid flow path 134 through the water circulation system 90 in the water cleaning mode is shown by a bold line.

During operation, screened wastewater is pumped from the trough 66 to the filter 114 by the supply pump 110 through a conduit. In a further embodiment, the screened wastewater may be collected in a collection tank. The first control valve 122 is positioned between the pump 110 and the filter 114 and actuated to a first position to allow the screened wastewater to flow to the filter 114. In the illustrated embodiment, the supply pump 110 is a 30 psi pump and pumps screened wastewater at about 20 gpm, although in further embodiments the supply pump 110 may be configured differently depending on the system parameters. In a further embodiment, the self-cleaning filter 114 is supplied by positive elevation pressure rather than a supply pump.

Generally, the screen assembly 30 of the wastewater screen apparatus 10 may allow particles as large as 0.02 inches to pass through. However, even though the diameter of each spray nozzle 94 is generally greater than the perforations in the screens, the spray nozzles 94 have a low tolerance to particles of about 0.01 inches. The spray nozzles 94 thereby perform best and with a consistent flow rate when clean water is supplied to the nozzles. The self-cleaning filter 114 cleans the screened wastewater further as the water passes through the filter 114 and filters out smaller solids and particles in the screened wastewater. The screened wastewater enters a first end 114A of the filter 114 and the cleaned water is discharged from a second end 114 of the filter 114. In a further embodiment, additional filters and strainers may be used to further clean the screened wastewater and lower the concentration of particles in the water.

The cleaned water then passes from the self-cleaning filter 114 to the high pressure pump 118, which then pumps the cleaned water back to the spray nozzles 94. The filter 114 provides a continuous supply of cleaned water to the high pressure pump 114. One example of a high pressure pump 114 used in the water recirculation system 90 is a Hydra-Cell® (pump provided by Wanner (Minneapolis, Minn.). In the illustrated embodiment, the output of the supply pump 110 and the output of the high pressure pump 118 are substantially equal. In the illustrated embodiment, controls valves 126, 130 direct the cleaned water along the fluid flow path 134. The second control valve 126 is positioned downstream of the filter 114 and upstream of the pump 118 and interfaces with a fresh water supply line 138, or secondary supply line. The control valve 126 is actuated to allow cleaned water to flow to the pump 118 and prevent fresh water from flowing to the filter 114. The third control valve 130 is positioned downstream of the second control valve 126 and upstream of the pump 118, and interfaces with the fresh water supply line 138 as well. The control valve 130 is actuated to allow cleaned water to flow to the pump 118 and prevent fresh water from flowing to the pump 118

A pressure relief valve 142 and a pressure sensor 146 are positioned downstream of the high pressure pump 118. The pressure sensor 146 measures the pressure in the fluid flow path 134 downstream of the pump 118. When fluid pressure in the flow path 134 is greater than a predetermined value, i.e., a maximum pressure capacity of the spray nozzles 94, the pressure relief valve 142 is actuated to divert a portion of the cleaned water from the fluid flow path 134 to a drain 150 for disposal or reuse. The remaining cleaned water is delivered to the spray nozzles 94.

During operation, the self-cleaning filter 114 becomes plugged with particles filtered from the screened wastewater and must be cleaned before operation can continue. Self-cleaning filters are used to prevent shutting down the water circulation system 90 and manually cleaning the filter 114. The self-cleaning filter 114 allows the water recirculation system 90 to continue operating such that a continuous supply of water is provided to the spray nozzles 94. Further, the high pressure pump 118 generally cannot withstand a stoppage of fluid flow through the pump 90, therefore, the water recirculation system 90 maintains a constant flow of water through the pump 118 while the filter 114 self-purges.

FIG. 3 illustrates the water circulation system 90 of FIG. 2 in a self-cleaning mode, in which fresh water from the fresh water supply line 138 is used to purge the filter 114 and provide a constant flow of water to the high pressure pump 118. One example of a self-cleaning filter used in the water recirculation system is an Easy Clean filter provided by Zero Gravity Filters, Inc. (Brighton, Mich.). It should be readily apparent to those of skill in the art that any type of self-cleaning or self-purging filter may be used with the water recirculation system 90. For example, a filter having more than one input port or output port for self-purging, or a filter with its own water supply to purge the filter. Although not shown in the illustrated embodiment, the filter 114 typically includes a housing, a filter element, inlet and outlet ports (for screened wastewater and purging fluid), and a differential pressure sensor 154.

The filter 114 includes the pressure differential sensor 154 hydraulically connected to the filter 114 to measure fluid pressure differences upstream and downstream of the filter 114, which indicates the filter plugged status. When pressure differential reaches a pre-determined point (i.e., a pressure drop through the filter 114 increases, the filter 114 is too plugged to maintain a constant supply of fluid to the high pressure pump 118), a regenerative mode (purging or cleaning) of the filter 114 is initiated. Generally, automated valves (not shown) within the filter 114 activate to purge the filter 114. The sensor 154 also actuates the three control valves 122, 126, 130 to direct fluid flow through the water recirculation system 90 in the self-cleaning mode, and thereby maintain a constant supply of fluid to the high pressure pump 118 to prevent damage to the pump 118. Thereby, fluid flow through the water recirculation system 90 is not interrupted during self-purging of the filter 114. A fluid flow path 158 is shown by the bold line in FIG. 3. In a further embodiment, the regenerative mode may be initiated by a timer or an operator button.

In the illustrated embodiment, the control valves 122, 126, 130 are rotated about 90° based upon the pressure differential. The second control valve 126 is positioned to allow fresh water to flow from the fresh water supply line 138 to the filter 114. Fresh water enters the second end 114B of the filter 114 to purge, or back wash, the filter 114 of particles separated from the screened wastewater. The fresh water and purged particles exit the first end 114A of the filter 114 and are discharged to a drain 162 for disposal or reuse. The first control valve 122 is actuated to allow fluid to flow from the filter 114 to the drain 162, and prevent screened wastewater from being pumped from the trough 66 to the filter 114. The screened wastewater then accumulates in the trough 66. If the high level sensor 102 is activated, the screened wastewater will be diverted through the trough drain 70. The third control valve 130 is positioned to allow a portion of the fresh water to flow from the fresh water supply line 138 to the high pressure pump 118, which then pumps the cleaned water back to the spray nozzles 94.

In the illustrated embodiment, the regenerative mode lasts for approximately 3 to 6 seconds; however, a length of the regenerative mode will vary depending upon the type of filter and the system parameters. Once the regenerative mode is complete, the control valves 122, 126, 130 are actuated back to the initial positions and the filter 114 returns to a filtering mode such that the water recirculation system 90 returns to the water cleaning mode, as shown in FIG. 2. In a further embodiment, the pressure differential sensor 154 continues measuring the pressure differential across the filter 114 and when the filter purge is complete, the control valves 122, 126, 130 are actuated back to the initial positions and the filter 114 returns to the filtering mode. During the regenerative mode, a small amount of fresh water is used by the water recirculation system 90 to purge the filter 114 and maintain a constant fluid flow through the high pressure pump 118. Further, all particulate matter and debris are removed from the filter with very little fluid required, providing an efficient purging process. The water recirculation system 90 uses significantly less fresh water than prior art systems because the cleaned water is recirculated to the spray nozzles 94.

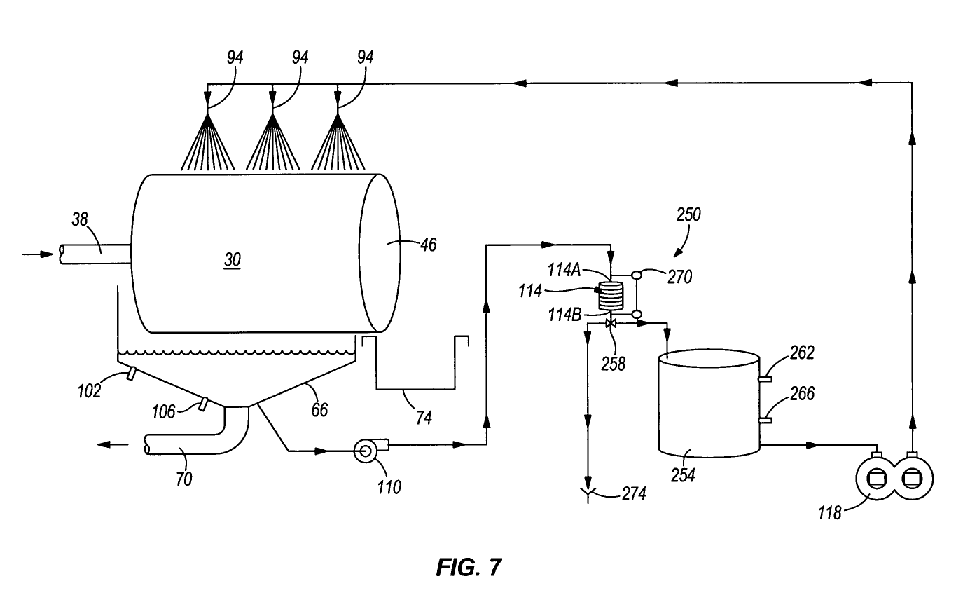

FIG. 4 illustrates a high pressure water system 166 for use in the water recirculation system 90 shown in FIGS. 2 and 3. The high pressure water system 166 includes the filter 114, the high pressure pump 118, the control valves 122, 126, 130, and the pressure relief valve 142 of the water circulation system 90. In the illustrated embodiment, the high pressure water system 166 is assembled and supplied as a unit for in-line installation with the wastewater screen apparatus 10. Although not shown in FIG. 4, in further embodiments the high pressure water system 166 may include a pressure regulating valve. The high pressure water system 166 also includes a control panel 170 for controlling operation of the filter 114 and the high pressure pump 118 with the control valves and sensors. For example, the control panel 170 monitors the pressure differential sensor 154, activates the control valves to initiate purging of the filter 114, and verifies and controls water levels in the trough 66 and accumulation tank (embodiment shown in FIG. 7).

The high pressure water system 166 includes five conduits for connecting the system 166 to the water circulation system 90 and the wastewater screen apparatus 10. A first water supply conduit 174 provides screened wastewater to the system 166 from the wastewater screen apparatus 10 and the supply pump 110 (FIG. 2). A purge conduit 178 discharges water and particles purged from the filter 114 to the drain 162. A second water supply conduit 182 discharges cleaned water from the high pressure pump 118 to the spray nozzles 94 and a relief conduit 186 discharges water diverted from the high pressure pump 118 by the pressure relief valve 142. A fresh water supply conduit 190 provides fresh water to the system 166 from the fresh water supply line 138 (FIG. 2).

Referring to FIG. 4, the first control valve 122 is positioned upstream of the filter 114, between the first water supply conduit 174 and the purge conduit 178. In the water cleaning mode, the first control valve 122 is actuated to allow screened wastewater from the water supply conduit 174 to flow to the filter 114. In the self-cleaning mode, the first control valve 122 is actuated to allow purged water and particles from the filter 114 to flow from the purge conduit 178 to the drain 162, as well as prevent screened wastewater from flowing to the filter 114.

The second control valve 126 is positioned downstream from the filter 114, between the fresh water supply conduit 190 and the third control valve 130, and the third control valve 130 is positioned upstream of the pump 18 between the fresh water supply conduit 190 and the pump 118. In the water cleaning mode, the second and third control valves 126, 130 are actuated to allow cleaned water to flow from the filter 114 to the high pressure pump 118. In the self-cleaning mode, the second and third control valves 126, 130 are actuated to allow fresh water to flow from the fresh water supply conduit 190 to the filter 114 and the high pressure pump 118.

The pressure relief valve 142 is positioned downstream from the high pressure pump 118, between the second water supply conduit 182 and the relief conduit 186. During either mode of operation, the relief valve 142 is actuated to allow cleaned water to flow from the pump 118 to the second water supply conduit 182, and thereby the spray nozzles 94 (FIG. 2). When fluid pressure from the high pressure pump 118 is greater than a predetermined valve, the relief valve 142 is actuated to divert cleaned water to the relief conduit 186. Once fluid pressure from the high pressure pump 118 returns to normal, the relief valve 142 is actuated back to the initial position.

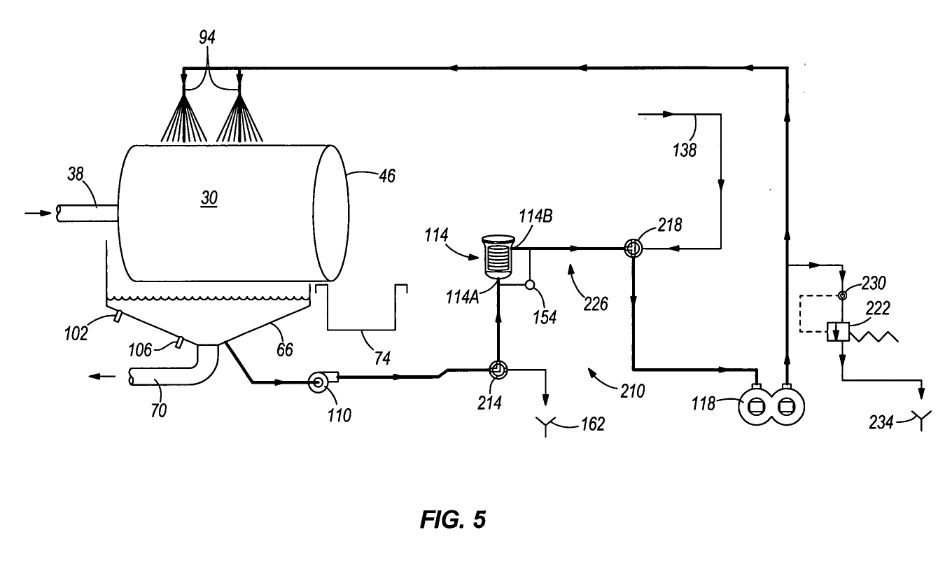

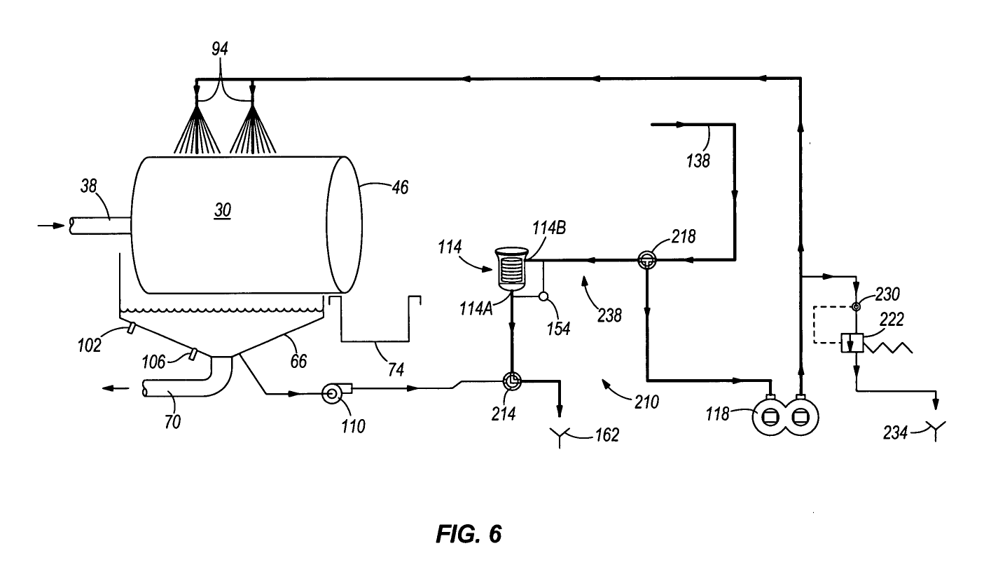

FIGS. 5 and 6 schematically illustrate a water recirculation system 210 according to another embodiment of the invention for use with the wastewater screen apparatus 10. The water recirculation system 210 is similar to and functions similarly to the water recirculation system 90 shown in FIGS. 2 and 3, and like features will be identified by the same reference numerals. For example, the water recirculation system 210 includes fewer control valves to control flow of water through the system 210. The water recirculation system 210 includes the supply pump 110 and a high pressure water system having the self-cleaning filter 114, the high pressure pump 118, two control valves 214, 218 for regulating the flow of screened wastewater, a pressure relief valve 222, and sensors for controlling flow through the water recirculation system 210.

FIG. 5 shows the water recirculation system 210 in a water cleaning mode, in which screened water from the wastewater screen apparatus 10 is further cleaning by the filter 110, 114 and returned to the spray nozzles 94 by the high pressure pump 118. A fluid flow path 226 through the water recirculation system 210 is shown by a bold line. During operation, the supply pump 110 pumps screened wastewater from the trough 66 to the filter 114. A first control valve 214 is positioned between the pump 110 and the filter 114, and is actuated to a position to allow screened wastewater to flow to the filter 114. The filter 114 cleans the screened wastewater by filtering out smaller solids and particulate matter still entrained in the screened wastewater. The filter 114 further cleans the screened wastewater such that the water is suitable for reuse with the spray nozzles 94 of the sprayer system 14 (FIG. 1). The screened wastewater enters the first end 114A of the filter 114 and the cleaned water is discharged from the second end 114B of the filter 114. It should be readily apparent to those of skill in the art that additional filters and strainers may be used to further clean the screened wastewater and lower the concentration of particles in the water.

The cleaned water then passes from the self-cleaning filter 114 to the high pressure pump 118, which then pumps cleaned water back to the spray nozzles 94. The filter 114 provides a continuous supply of cleaned water to the high pressure pump 118 and a second control valve 218 directs the cleaned water along the fluid flow path 226. The second control valve 218 is positioned downstream of the filter 114 and upstream of the pump 118, and interfaces with the fresh water supply line 138. The control valve 218 is actuated to all cleaned water to flow to the pump 118 and prevent fresh water from entering the fluid flow path 226, i.e., flowing to the filter 114 or the pump 118.

A pressure relief valve 222 and a pressure sensor 230 are positioned downstream of the high pressure pump 118. The pressure sensor 230 measures the pressure in the fluid flow path 226 downstream of the pump 118 and when fluid pressure in the flow path 226 is greater than a predetermined value 222, the pressure relief valve is actuated to divert a portion of the cleaned water from the fluid flow path 226 to a drain 234 for disposal or reuse. The remaining cleaned water is delivered to the spray nozzles 94.

As described above, during operation the self-cleaning filter 114 becomes plugged with particles filtered from the screened wastewater and must be cleaned before operation can continue. FIG. 6 illustrates the water recirculation system 210 of FIG. 5 in a self-cleaning mode, in which fresh water from the fresh water supply line 138 is used to purge the filter 114 and provide a constant flow of water to the high pressure pump 118.

The filter 114 includes the pressure differential sensor 154 to measure fluid pressure differences across the filter 114, which indicates the filter plugged status. When the pressure differential reaches a pre-determined point, the regenerative mode (purging or cleaning) of the filter 114 is initiated. The sensor 154 also actuates the control valves 214, 218 to direct fluid flow through the water recirculation system 210 in the self-cleaning mode, and thereby maintain a constant supply of fluid to the high pressure pump 118 to prevent damage to the pump 118. A fluid flow path 238 is shown by the bold line in FIG. 6.

In the illustrated embodiment, the control valves 214, 218 are rotated about 90° based upon the sensed pressure differential. The second control valve 218 is actuated to allow fresh water to flow from the fresh water supply line 138 to the filter 114 and to the high pressure pump 118. A portion of the fresh water enters the second end 114B of the filter 114 to purge, or back wash, the filter 114 of particles separated from the screened wastewater. The fresh water and purged particles exit the first end 114A of the filter 114 and are discharged from the system for disposal or reuse. The first control valve 214 is actuated to allow fluid to flow from the filter 114 to the drain 162, and prevent screened wastewater from being supplied from the trough 66 to the filter 114 by the supply pump 110. If the high level sensor 102 is activated, the screened wastewater that has built up in the trough 66 will be discharged through the trough drain 70. The remainder of the fresh water flows from the fresh water supply line 138 to the high pressure pump 118, which then pumps the water to the spray nozzles 94 of the sprayer system 14 (FIG. 1).

In the illustrated embodiment, the regenerative mode lasts for approximately 3 to 6 seconds. Once the regenerative mode is complete, the controls valves 214, 218 are actuated back to the initial positions and the filter 114 returns to the filtering mode, such that the water recirculation system 210 returns to the water cleaning mode shown in FIG. 5.

In the illustrated embodiment, the high pressure water system includes the self-cleaning filter 114, the high pressure pump 118, the first and second control valves 214 and 218, the pressure relief valve 222, and the sensors 154, 230. In a further embodiment, the high pressure water system includes a control panel for controlling operation of the filter 114 and the high pressure pump 118 with the control valves and sensors, as discussed above with respect to FIG. 4. Although not shown in FIGS. 5 and 6, the high pressure water system may be assembled and supplied as a unit for in-line installation with the wastewater screen apparatus 10. It should be readily apparent to those of skill in the art that additional components or fewer components than those described above may be part of the high pressure water system.

FIG. 7 schematically illustrates a water recirculation system 250 according to one embodiment of the invention for use with the wastewater screen apparatus 10. The water recirculation system 250 is similar to and functions similarly to the water recirculation system 90 shown in FIGS. 2 and 3, and like features will be identified by the same reference numerals. However, one difference with the water recirculation system 90 shown in FIGS. 2 and 3 is that the water recirculation system 250 does not include a fresh water supply line to purge the self-cleaning filter 114 and maintain a constant fluid flow to the high pressure pump 118. Rather, the water recirculation system 210 is a closed loop system that uses screened wastewater to purge the filter 114 and an accumulation tank 254 to maintain a constant fluid flow to the high pressure pump 118.

The water recirculation system 250 includes the supply pump 110 and a high pressure water system having the self-cleaning filter 114, the high pressure pump 118, a control valve 258 for regulating the flow of screened wastewater, and sensors for controlling flow through the water recirculation system 250. During operation in a filtering mode, the supply pump 110 pumps screened wastewater from the trough 66 to the filter 114 through a conduit. In the illustrated embodiment, the supply pump 110 is a 30 psi pump that pumps screened wastewater at about 35 gpm, although in further embodiments, the supply pump 110 may be configured differently based upon the system parameters. The self-cleaning filter 114 cleans the screened wastewater further as the water passes through the filter 114. Screened water enters the first end 114A of the filter 114, whereby the filter 114 filters out smaller solids and particulate matter entrained in the screened wastewater, and cleaned water is discharged from the second end 114B of the filter 114. In a further embodiment, additional filters and strainers may be used to further clean the screened wastewater and lower the concentration of particles in the water.

The cleaned water then passes from the self-cleaning filter 114 to the accumulation tank 254. A first control valve 258 is positioned between the filter 114 and the tank 254 and is actuated to allow the cleaned water to flow to the tank 254. The tank 254 stores cleaned water, which is then discharged to the high pressure pump 118 and then pumped back to the spray nozzles 94. In the illustrated embodiment, the accumulation tank 254 holds up to 60 gallons of cleaned water and the pump 118 pumps cleaned water at about 20 gpm. Because the supply pump 110 runs faster than the high pressure pump 118, cleaned water is accumulated in the tank 254 to ensure a constant fluid flow is delivered to the high pressure pump 118, including when the self-cleaning filter is purged. The tank 254 includes a high level sensor 262 and a low level sensor 266 for maintaining a desired amount of water in the tank 254, as will be discussed below. In a further embodiment, a pressure relief valve and pressure sensor (not shown) are positioned downstream of the high pressure pump 118 to relieve pressure in the fluid flow path during operation, as described above with respect to FIGS. 2 and 3.

A pressure differential sensor 270 measures fluid pressure across the self-cleaning filter 114 to determine whether the filter 114 is plugged with particles filtered from the screened wastewater. When the pressure differential reaches a pre-determined set point, the regenerative mode (purging or cleaning) of the filter 114 is initiated and the sensor 270 actuates the control valve 258 to direct fluid flow through the water recirculation system 250 to allow purging of the filter 114. In the illustrated embodiment, the control valve 258 is actuated to allow screened wastewater to flow to purge the filter 114 then discharge the purged water and particles through a drain 274 for disposal or reuse. The self-cleaning filter 114 uses screened wastewater from the supply pump 110 to purge the filter 114 of particles separated from the screened wastewater. In a further embodiment, the self-cleaning filter 114 is purged by a separate water source, such as an internal water source or a fresh water supply, that does not supply the accumulation tank 254.

Cleaned wastewater stored in the accumulation tank 254 is used to maintain a constant supply of fluid to the high pressure pump 118 and prevent damage to the pump 118. The high level sensor 262 and the low level sensor 262 are used for maintaining a desired water level in the tank 254. When the water level reaches the low level sensor 266, there is sufficient water to operate the high pressure pump 118 while the filter 114 is in the regenerative mode. However, if the water level is below the low level sensor 266 the filter 114 cannot operate in the regenerative mode. When the water level reaches the high level sensor 262, the supply pump 110 is temporarily turned off to prevent the accumulation tank 254 from overflowing.

In the illustrated embodiment, the regenerative mode lasts for approximately 3 to 6 seconds; however, the regenerative mode length will vary depending upon the filter used and the system parameters. Once the regenerative mode is complete, the control valve 258 is actuated is actuated back to the initial position and the filter 114 returns to the filtering mode, such that the water recirculation system 250 returns to the water cleaning mode.

In the illustrated embodiment, the high pressure water system includes the self-cleaning filter 114, the high pressure pump 118, the accumulation tank 254, the control valve 258, and the sensors 262, 266, 270. In a further embodiment, the high pressure water system includes a control panel for controlling operation of the filter 114 and the high pressure pump 118 with the control valves and sensors. Although not shown in FIG. 7, the high pressure water system may be assembled and supplied as a unit for in-line installation with the wastewater screen apparatus 10. It should be readily apparent to those of skill in the art that additional components or fewer components than those described above may be part of the high pressure water system.

It should be readily apparent to those of skill in the art that the water recirculation system may be adapted for use with other fluids. For example, with a screen apparatus processing a high value fluid, such as juice or chaff from a soybean refinery, that cannot be diluted with water. Typically, the filter would need to be purged by the same fluid or a compatible fluid that is not oil.

Various features and advantages of the invention are set forth in the following claims.

What is claimed is:

1. In a food processing system having a wastewater screen apparatus, a recirculation system comprising:
a self-cleaning filter for receiving fluid from the wastewater screen apparatus, the filter operable in a first mode wherein the filter screens particulate matter from the fluid and the filter operable in a second mode wherein the filter is purged of the screened matters;
a pump for pumping cleaned fluid from the filter to the wastewater screen apparatus, wherein a substantially continuous supply of cleaned fluid is delivered to the pump,
wherein a first fluid flow path fluidly connects the wastewater screen apparatus, the filter, and the pump; and
a control valve operable to direct fluid along the first fluid flow path when the filter is in the first mode and operable to direct fluid and screened matter along a second fluid flow path when the filter is in the second mode.

2. The recirculation system of claim 1, and further comprising a supply pump for pumping fluid from the wastewater screen apparatus to the filter.

3. The recirculation system of claim 1 wherein the filter includes a pressure differential sensor for sensing when the filter is plugged and initiating the second mode of the filter.

4. The recirculation system of claim 3 wherein the sensor actuates the control valve to direct fluid and screened matter along the second fluid flow path.

5. The recirculation system of claim 1, and further comprising a pressure relief valve positioned downstream of the pump, the pressure relief valve operable to divert a portion of the cleaned fluid from the water recirculation system.

6. The recirculation system of claim 1 wherein the second mode lasts between about 3 seconds and about 6 seconds.

7. The recirculation system of claim 1, and further comprising a sprayer system positioned downstream of the pump and fluidly connected to the first fluid flow path, wherein the pump delivers the cleaned fluid to the sprayer system.

8. The recirculation system of claim 1, and further comprising:
a fluid supply line fluidly connected to the first fluid flow path downstream of the filter and upstream of the pump; and
a second control valve positioned downstream of the filter, wherein when the filter is in the first mode the second control valve is actuated to a first position to prevent fluid from the fluid supply line from entering the first fluid flow path, and
further wherein when the filter is in the second mode the second control valve is actuated to a second position to allow a portion of fluid from the fluid supply line to flow to the pump through the first fluid flow path and a remainder of the fluid from the fluid supply line to flow to the filter through the second fluid flow path.

9. The recirculation system of claim 1, and further comprising:
a fluid supply line fluidly connected to the first fluid flow path downstream of the filter and upstream of the pump; and
a second control valve positioned downstream of the filter, wherein when the filter is in the first mode the second control valve is actuated to a first position to prevent fluid from the fluid supply line from entering the first fluid flow path, and when the filter is in the second mode the second control valve is actuated to a second position to allow a portion of the fluid from the fluid supply line to flow to the filter through the second fluid flow path; and
a third control valve positioned upstream of the pump, wherein when the filter is in the first mode the third control valve is actuated to a first position to prevent fluid from the fluid supply line from entering the first fluid flow path, and when the filter is in the second mode the third control valve is actuated to a second position to allow a portion of fluid from the fluid supply line to flow to the pump through the first fluid flow path.

10. The recirculation system of claim 1, and further comprising an accumulation tank disposed in the first fluid flow path and positioned between the filter and the pump, wherein the accumulation tank stores cleaned fluid from the filter to provide a continuous supply of cleaned fluid to the pump.

11. A recirculation system for use with a wastewater screen apparatus, the water recirculation system comprising:
a self-cleaning filter for receiving fluid from the wastewater screen apparatus, the filter operable in a first mode wherein the filter screens particulate matter from the fluid and the filter operable in a second mode wherein the filter is purged of the screened matter;
a first pump for pumping water from the wastewater screen apparatus to the filter;
a second pump for pumping cleaned fluid from the filter to the wastewater screen apparatus, wherein a substantially continuous supply of cleaned fluid is delivered to the second pump,
wherein a first fluid flow path fluidly connects the wastewater screen apparatus, the first pump, the filter, and the second pump;
a fluid supply line fluidly connected to the first fluid flow path downstream of the filter and upstream of the pump;
a first control valve operable to direct fluid from the wastewater screen apparatus to the filter through the first fluid flow path when the filter is in the first mode, and the first control valve operable to direct fluid and screened matter from the filter and through a second fluid flow path when the filter is in the second mode; and
a second control valve positioned downstream of the filter, wherein when the filter is in the first mode the second control valve is actuated to a first position to prevent fluid from the fluid supply line from entering the first fluid flow path, and when the filter is in the second mode the second control valve is actuated to a-second position to allow a portion of fluid from the fluid supply line to flow to the pump and a remainder of the fluid from the fluid supply line to flow to the filter through the second fluid flow path.

12. The recirculation system of claim 11 wherein the second control valve allows a portion of the fluid from the fluid supply line to flow to the filter through the second fluid flow path when the filter is in the second mode, the water recirculation system further comprising a third control valve positioned upstream of the pump, wherein when the filter is in the second mode the third control valve is actuated to allow a portion of fluid from the fluid supply line to flow to the pump through the first fluid flow path.

13. The recirculation system of claim 11 wherein the filter includes a pressure differential sensor for sensing when the filter is plugged and initiating the second mode of the filter.

14. The recirculation system of claim 13 wherein the sensor actuates the control valves to the respective second mode positions.

15. The recirculation system of claim 11, and further comprising a pressure relief valve positioned downstream of the pump, the pressure relief valve operable to divert a portion of the cleaned fluid from the first fluid flow path.

16. A recirculation system for use with a wastewater screen apparatus, the water recirculation system comprising:
a self-cleaning filter for receiving fluid from the wastewater screen apparatus, the filter operable in a first mode wherein the filter screens particulate matter from the fluid and the filter operable in a second mode wherein the filter is purged of the screened matter;
a first pump for pumping water from the wastewater screen apparatus to the filter;
an accumulation tank positioned downstream of the filter, wherein the accumulation tank stores cleaned fluid from the filter;
a second pump for pumping cleaned fluid from the accumulation tank to the wastewater screen apparatus, wherein a substantially continuous supply of cleaned fluid is delivered to the pump from the accumulation tank;
wherein a first fluid flow path fluidly connects the wastewater screen apparatus, the first pump, the filter, the accumulation tank, and the second pump;
a control valve operable to direct fluid along the first fluid flow path when the filter is in the first mode and operable to divert fluid and screened matter from the first fluid flow path when the filter is in the second mode.

17. The recirculation system of claim 16 wherein the control valve is positioned downstream of the filter.

18. The recirculation system of claim 16 wherein the first pump pumps fluid at a rate greater than a rate that the second pump pumps cleaned fluid.

19. The recirculation system of claim 16 wherein the accumulation tank includes at least one sensor for maintaining a desired amount of cleaned fluid in the tank.

20. A high pressure water system for use with a wastewater screen apparatus, the high pressure water system comprising:
a first fluid supply conduit for receiving fluid from the wastewater screen apparatus;
a fluid delivery conduit for delivering fluid to the wastewater screen apparatus;
a self-cleaning filter for receiving fluid from the first fluid supply conduit, the filter operable in a first mode wherein the filter screens particulate matter from the fluid and operable in a second mode wherein the filter is purged of the screened matter;
a purge conduit fluidly connected to the first fluid supply conduit;
a first control valve operable to direct fluid from the first fluid supply conduit to the filter when the filter is in the first mode, and operable to direct fluid from the filter to the purge conduit when the filter is in the second mode;
a pump for pumping fluid from the filter to the fluid delivery conduit, wherein a substantially continuous supply of fluid is delivered to the pump, and further wherein a fluid flow path extends between the filter and the pump;
a second water supply for delivering a second fluid to the fluid flow path when the filter is in the second mode; and
a second control valve disposed in the fluid flow path, the second control valve operable to prevent second fluid from the second water supply from entering the fluid flow path when the filter is in the first mode, and the second control valve operable to allow a portion of second fluid to flow to the filter and a remainder of second fluid to flow to the pump when the filter is in the second mode.

21. The high pressure water system of claim 20, and further comprising:
a pressure relief conduit fluidly connected to the fluid delivery conduit downstream of the pump; and
a pressure relief valve disposed between the pressure relief conduit and the fluid delivery conduit, the relief valve operable to divert fluid from the fluid delivery conduit to the pressure relief conduit.

22. The high pressure water system of claim 20, and further comprising a third control valve disposed in the fluid flow path, wherein when the filter is in the second mode the second control valve allows a portion of second fluid from the second fluid supply conduit to flow to the filter and the third control valve allows the remainder of second fluid from the second fluid supply conduit to flow to the pump.

23. The high pressure water system of claim 20 wherein the filter includes a pressure differential sensor for sensing when the filter is plugged and initiating the second mode of the filter.

24. A wastewater screening system comprising:
a wastewater screen apparatus of a double screen type for cleaning particulate matter from wastewater, wherein screened wastewater is collected in a trough;
a recirculation system for further cleaning particulate matter from the screened wastewater and delivering the cleaned water to the wastewater screen apparatus, the water recirculation system comprising:
a self-cleaning filter for receiving screened wastewater from the trough, the filter operable in a first mode wherein the filter screens matter from the screened wastewater and operable in a second mode wherein the filter is purged of the screened matter;
a pump for pumping cleaned water from the filter to the wastewater screen apparatus, wherein a substantially continuous supply of cleaned water is delivered to the pump,
wherein a first fluid flow path fluidly connects the trough, the filter, the pump, and the wastewater screen apparatus; and
a control valve operable to direct screened wastewater and cleaned water along the first fluid flow path when the filter is in the first mode, and operable to direct purged water and screened matter through a second fluid flow path when the filter is in the second mode.

25. The wastewater screening system of claim 24 wherein the wastewater screen apparatus includes a sprayer system and the pump pumps cleaned water to the sprayer system.

26. The wastewater screening system of claim 25 wherein the sprayer system is of a reciprocating type sprayer system.

27. The wastewater screening system of claim 25 wherein the sprayer system is of a sequential type sprayer system.

28. The wastewater screening system of claim 24 wherein the wastewater screen apparatus comprises:
a frame;
an outer drum rotatably mounted to the frame, the outer drum having portions defining a generally cylindrical perforated screen that allows passage of water therethrough and retains particulate matter above a first size; and
an inner drum mounted rotatably mounted within the outer drum, the inner drum having portions defining a generally cylindrical perforated screen that allows passage of water therethrough and retains particulate matter above a second size, wherein the second size is greater than the first size.

29. The wastewater screening system of claim 24, and further comprising a supply pump for pumping fluid from the wastewater screen apparatus to the filter.

30. The wastewater screening system of claim 24 wherein the filter includes a pressure differential sensor for sensing when the filter is plugged and initiating the second mode of the filter.

31. The wastewater screening system of claim 30 wherein the sensor actuates the control valve to direct fluid and screened matter along the second fluid flow path.

32. The wastewater screening system of claim 24, and further comprising a pressure relief valve positioned downstream of the pump, the pressure relief valve operable to divert a portion of the cleaned fluid from the recirculation system.

33. The wastewater screening system of claim 24, and further comprising:
a fluid supply line fluidly connected to the first fluid flow path downstream of the filter and upstream of the pump; and
a second control valve positioned downstream of the filter, wherein when the filter is in the first mode the second control valve is actuated to a first position to prevent fluid from the fluid supply line from entering the first fluid flow path, and
further wherein when the filter is in the second mode the second control valve is actuated to a second position to allow a portion of fluid from the fluid supply line to flow to the pump through the first fluid flow path and a remainder of the fluid from the fluid supply line to flow to the filter through the second fluid flow path.

34. The wastewater screening system of claim 24, and further comprising:
a fluid supply line fluidly connected to the first fluid flow path downstream of the filter and upstream of the pump; and
a second control valve positioned downstream of the filter, wherein when the filter is in the first mode the second control valve is actuated to a first position to prevent fluid from the fluid supply line from entering the first fluid flow path, and when the filter is in the second mode the second control valve is actuated to a second position to allow a portion of the fluid from the fluid supply line to flow to the filter through the second fluid flow path; and
a third control valve positioned upstream of the pump, wherein when the filter is in the first mode the third control valve is actuated to a first position to prevent fluid from the fluid supply line from entering the first fluid flow path, and when the filter is in the second mode the third control valve is actuated to a second position to allow a portion of fluid from the fluid supply line to flow to the pump through the first fluid flow path.

35. The wastewater screening system of claim 24, and further comprising an accumulation tank disposed in the first fluid flow path and positioned between the filter and the pump, wherein the accumulation tank stores cleaned fluid from the filter to provide a continuous supply of cleaned fluid to the pump.

36. A recirculation system for use with a wastewater screen apparatus, the recirculation system comprising:
a self-cleaning filter for receiving fluid from the wastewater screen apparatus, the filter operable in a first mode wherein the filter screens particulate matter from the fluid and the filter operable in a second mode wherein the filter is purged of the screened matters;
a pump for pumping cleaned fluid from the filter to the wastewater screen apparatus, wherein a substantially continuous supply of cleaned fluid is delivered to the pump,
wherein a first fluid flow path fluidly connects the wastewater screen apparatus, the filter, and the pump; and
a control valve operable to direct fluid along the first fluid flow path when the filter is in the first mode and operable to direct fluid and screened matter along a second fluid flow path when the filter is in the second mode.

37. The recirculation system of claim 36, and further comprising a supply pump for pumping fluid from the wastewater screen apparatus to the filter.

38. The recirculation system of claim 36, and further comprising:
a fluid supply line fluidly connected to the first fluid flow path downstream of the filter and upstream of the pump; and
a second control valve positioned downstream of the filter, wherein when the filter is in the first mode the second control valve is actuated to a first position to prevent fluid from the fluid supply line from entering the first fluid flow path, and
further wherein when the filter is in the second mode the second control valve is actuated to a second position to allow a portion of fluid from the fluid supply line to flow to the pump through the first fluid flow path and a remainder of the fluid from the fluid supply line to flow to the filter through the second fluid flow path.

39. The recirculation system of claim 36, and further comprising:
a fluid supply line fluidly connected to the first fluid flow path downstream of the filter and upstream of the pump; and
a second control valve positioned downstream of the filter, wherein when the filter is in the first mode the second control valve is actuated to a first position to prevent fluid from the fluid supply line from entering the first fluid flow path, and when the filter is in the second mode the second control valve is actuated to a second position to allow a portion of the fluid from the fluid supply line to flow to the filter through the second fluid flow path; and
a third control valve positioned upstream of the pump, wherein when the filter is in the first mode the third control valve is actuated to a first position to prevent fluid from the fluid supply line from entering the first fluid flow path, and when the filter is in the second mode the third control valve is actuated to a second position to allow a portion of fluid from the fluid supply line to flow to the pump through the first fluid flow path.

40. The recirculation system of claim 36, and further comprising an accumulation tank disposed in the first fluid flow path and positioned between the filter and the pump, wherein the accumulation tank stores cleaned fluid from the filter to provide a continuous supply of cleaned fluid to the pump.
